(19) United States
(12) Patent Application Publication
(10) Pub. No.: US 2026/0181603 A1
(43) Pub. Date: Jun. 25, 2026

(54) Communication Method and Apparatus for a Wireless Battery Management System

(71) Applicant: Zhejiang Zgmicro Company Limited, Shaoxing (CN)

(72) Inventor: Bin Xu, Shaoxing (CN)

(73) Assignee: Zhejiang Zgmicro Company Limited, Shaoxing (CN)

(21) Appl. No.: 19/417,040

(22) Filed: Dec. 11, 2025

(30) Foreign Application Priority Data
Dec. 24, 2024 (CN) 2024119134938

(51) Int. Cl. H04W 72/0446; H01M 10/42; H04W 72/30

(52) U.S. Cl. CPC H04W 72/0446; H01M 10/425; H04W 72/30; H01M 2010/4271

(57) ABSTRACT

The present disclosure provides a communication method and apparatus for a wireless battery management system. The wireless battery management system comprises one central device and a plurality of peripheral devices. The communication method comprises: the central device and the plurality of peripheral devices form a point-to-multipoint bidirectional communication link; when the bidirectional communication link is a periodic advertising with hierarchical responses link, each periodic advertising interval in the bidirectional communication link comprises a plurality of subevent sets, and the plurality of subevent sets comprise at least two target subevent sets, each target subevent set containing at least one subevent, and each subevent being configured with a plurality of response slots. Among the at least two target subevent sets, response slot spacings of different target subevent sets are different, and/or response slot delays of different target subevent sets are different. The present disclosure can support hierarchical transmission of battery parameters.

### CROSS-REFERENCE OF RELATED APPLICATIONS

The present application claims priority of Chinese Patent Application No. 2024119134938 filed in China on Dec. 24, 2024, the entire contents of which is incorporated herein by reference.

### FIELD OF THE INVENTION

The present disclosure relates to the technical field of wireless communication, and specifically relates to a communication method, apparatus, and related equipment for a WBMS.

### BACKGROUND

As a concept of low carbon has gained widespread recognition and driven rapid development of electric vehicles, people have increasingly higher requirements for energy storage efficiency, safety, and reliability of automotive power batteries. Consequently, higher demands are also placed on a Battery Management System (BMS), which controls safe, efficient, and long-life operation of batteries. For example, electric vehicle manufacturers are increasingly inclined to use a Wireless Battery Management System (WBMS).

WBMS can reduce low-voltage wiring harnesses that occupy 10% of space of an entire battery pack for automotive power batteries, thereby enabling lightweight design or increasing battery capacity. It also reduces a mechanical failure rate caused by wiring harness friction, allows for more flexible design, and facilitates production and maintenance. As a result, automotive power batteries become safer, more reliable, and have lower overall costs.

A wireless communication function of WBMS requires point-to-multipoint bidirectional communication. The existing solutions that use a combination of multiple point-to-point bidirectional connections based on Wireless Local Area Network (WLAN), Zigbee, and Bluetooth can support point-to-multipoint bidirectional communication. However, the number of direct connections supported by the above-mentioned protocols is limited, which leads to a limited number of accessible terminal nodes. Alternatively, access can only be achieved through relay nodes in a tree-like topology, making it difficult to guarantee communication latency.

A Periodic Advertising With Responses (PAWR) protocol in Bluetooth Low Energy (BLE) technology can support point-to-multipoint bidirectional communication and adopts a star topology, which can support access of a relatively large number of terminal nodes. However, the PAWR protocol has the same subevent interval and the same response slot length. Therefore, the PAWR protocol is not conducive to supporting effective transmission of response data of different lengths in a WBMS, nor is it convenient for supporting hierarchical transmission of response data with different urgency levels or different latency requirements in the WBMS.

In other words, the point-to-multipoint bidirectional communication methods provided by the related technologies cannot support the hierarchical transmission of battery parameters with different data lengths and different latency requirements while balancing low communication latency and a larger number of accessible terminal nodes.

### SUMMARY

The purpose of the present disclosure is to provide a communication method, a communication apparatus, and related equipment for a Wireless Battery Management System (WBMS), which can support a hierarchical transmission of battery parameters with different data lengths and different latency requirements while balancing low communication latency and a larger number of accessible terminal nodes.

In a first aspect, a communication method for a wireless battery management is provided. The wireless battery management system comprises a central device and a plurality of peripheral devices, the communication method comprises: transmitting, by the central device, a same auxiliary advertising PDU to each of the plurality of peripheral devices, so that the plurality of peripheral devices establish connections with the central device based on the auxiliary advertising PDU to form a point-to-multipoint bidirectional communication link; wherein when the bidirectional communication link is a periodic advertising with hierarchical responses (PAWHR) link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots; among the at least two target subevent sets, response slot spacings of different target subevent sets are different, and/or response slot delays of different target subevent sets are different; and the response slots are at least used for the peripheral devices to report battery parameters to the central device based on the bidirectional communication link.

In a second aspect, a communication method for a wireless battery management system is provided. The wireless battery management system comprises a central device and a plurality of peripheral devices. The communication method is applied to the central device and comprises: transmitting a same auxiliary advertising PDU to the plurality of peripheral devices respectively, so that the plurality of peripheral devices establish connections with the central device based on the auxiliary advertising PDU to form a point-to-multipoint bidirectional communication link; wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots; among the at least two target subevent sets, response slot spacings of different target subevent sets are different, and/or response slot delays of different target subevent sets are different; and the response slots are at least used for the central device to receive battery parameters reported by the peripheral devices based on the bidirectional communication link.

In a third aspect, a communication method for a wireless battery management system is provided. The wireless battery management system comprises a central device and a plurality of peripheral devices. The communication method is applied to a target peripheral device being one peripheral device among the plurality of peripheral devices, and comprises: receiving an auxiliary advertising PDU transmitted by the central device, and establishing a connection with the central device based on the auxiliary advertising PDU, to form a point-to-multipoint bidirectional communication link with the central device; wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots; among the at least two target subevent sets, response slot spacings of different target subevent sets are different, and/or response slot delays of different target subevent sets are different; and the target peripheral device corresponds to at least one subevent in each target subevent set respectively, and reports battery parameters to the central device based on the bidirectional communication link in at least one response slot of the corresponding subevent.

In a fourth aspect, a communication apparatus for a wireless battery management system is provided. The wireless battery management system comprises a central device and a plurality of peripheral devices. The communication apparatus is applied to the central device, and comprises: an Auxiliary Advertising Transmitting Module, configured to transmit a same auxiliary advertising PDU to the plurality of peripheral devices respectively, so that the plurality of peripheral devices establish connections with the central device based on the auxiliary advertising PDU to form a point-to-multipoint bidirectional communication link; wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots; among the at least two target subevent sets, response slot spacings of different target subevent sets are different, and/or response slot delays of different target subevent sets are different; and the response slots are at least used for the central device to receive battery parameters reported by the peripheral devices to the central device based on the bidirectional communication link.

In the present disclosure, the central device and the plurality of peripheral devices that form the WBMS can establish a point-to-multipoint PAWHR link. Each periodic advertising interval in the PAWHR link comprises at least two target subevent sets. The hierarchical response is realized by setting different response slot spacings and/or different response slot delays for different target subevent sets among the at least two target subevent sets. This can adapt to variable communication requirements of different response latencies and response data of different lengths, enabling the WBMS to support the hierarchical transmission of battery parameters while balancing low communication latency and a larger number of accessible terminal nodes.

There are many other objects, together with the foregoing attained in the exercise of the disclosure in the following description and resulting in the embodiment illustrated in the accompanying drawings.

### BRIEF DESCRIPTION OF THE DRAWINGS

These and other features, aspects, and advantages of the present disclosure will become better understood with regard to the following description, appended claims, and accompanying drawings wherein:

FIG. 1 is a schematic flow chart of a communication method for a Wireless Battery Management System (WBMS) provided according to one embodiment of the present disclosure;

FIG. 2 is a schematic diagram of a WBMS provided according to one embodiment of the present disclosure;

FIG. 3 is a time slot diagram of periodic advertising with hierarchical responses (PAWHR) provided according to one embodiment of the present disclosure;

FIG. 4(a) is a time slot diagram of a PAWHR subevent provided according to one embodiment of the present disclosure;

FIG. 4(b) is another time slot diagram of a PAWHR subevent provided according to one embodiment of the present disclosure;

FIG. 5 is another schematic flow chart of a communication method for a WBMS provided according to one embodiment of the present disclosure;

FIG. 6 is yet another schematic flow chart of a communication method for a WBMS provided according to one embodiment of the present disclosure;

FIG. 7 is a schematic structural diagram of a communication apparatus for a WBMS provided according to one embodiment of the present disclosure;

FIG. 8 is another schematic structural diagram of a communication apparatus for a WBMS provided according to one embodiment of the present disclosure; and

FIG. 9 is a schematic structural diagram of an electronic device provided according to one embodiment of the present disclosure.

### DETAILED DESCRIPTION

The detailed description of the disclosure is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

To clarify the objectives, technical solutions, and advantages of the embodiments of the present disclosure, the technical solutions in the embodiments of the present disclosure will be clearly and completely described below in conjunction with the accompanying drawings in the embodiments of the present disclosure. Obviously, the described embodiments are part of the embodiments of the present disclosure, rather than all the embodiments. Based on the embodiments of the present disclosure, all other embodiments obtained by those skilled in the art without making creative efforts shall fall within the protection scope of the present disclosure.

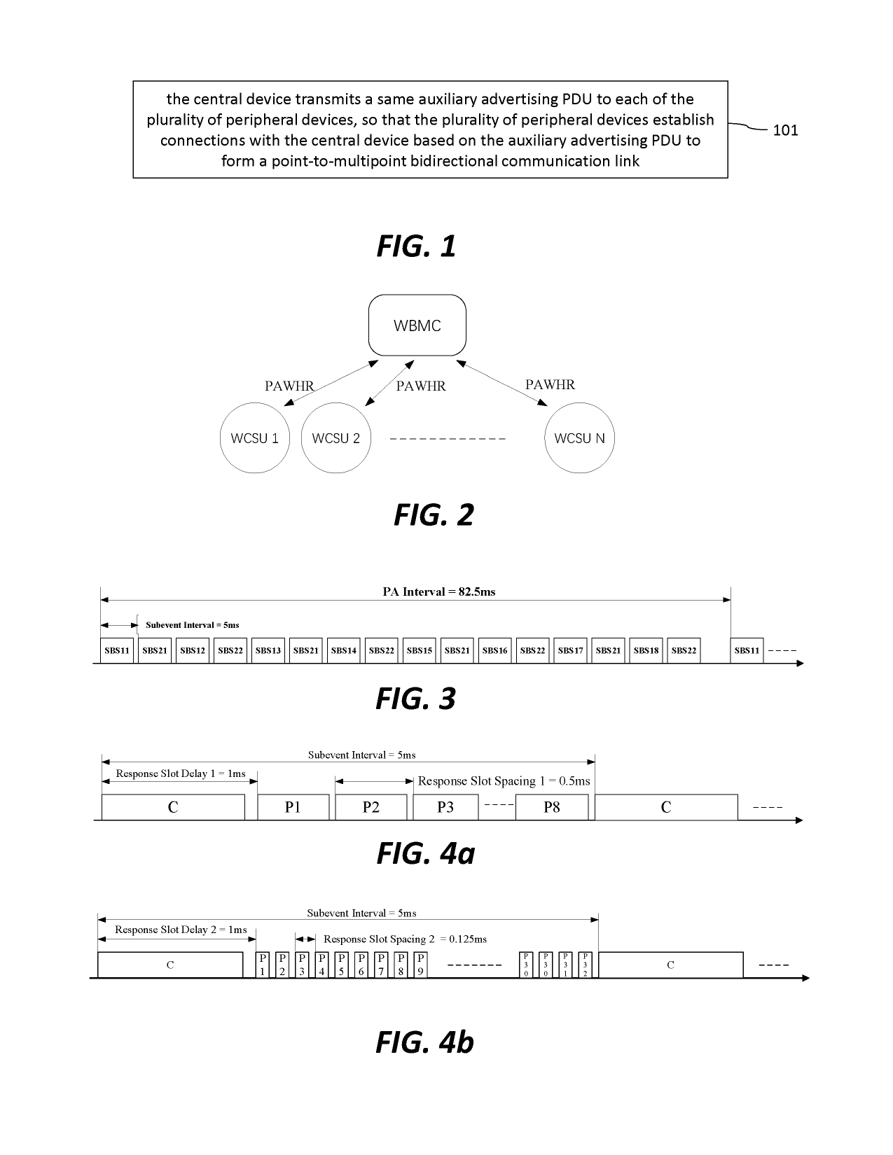

A communication method for a Wireless Battery Management System (WBMS) is provided according to one embodiment of the present disclosure. The WBMS comprises one central device and a plurality of peripheral devices. As shown in FIG. 1, the communication method comprises the following operations.

At 101: the central device transmits a same Auxiliary Advertising Protocol Data Unit (PDU) to each of the plurality of peripheral devices, so that the plurality of peripheral devices establish connections with the central device based on the Auxiliary Advertising PDU to form a point-to-multipoint bidirectional communication link.

When the bidirectional communication link is a Periodic Advertising With Hierarchical Responses (PAWHR) link, each periodic advertising interval in the bidirectional communication link comprises a plurality of subevent sets, and the plurality of subevent sets comprise at least two target subevent sets. Each target subevent set contains at least one subevent, and each subevent is configured with a plurality of response slots. Among the at least two target subevent sets, response slot spacings of different target subevent sets are different, and/or response slot delays of different target subevent sets are different.

The response slots are at least used for the peripheral devices to report battery parameters to the central device based on the bidirectional communication link.

Without loss of generality, the WBMS can be applied in electric vehicle scenarios or battery energy storage scenarios.

Exemplarily, when the WBMS is applied in an electric vehicle scenario, it can be used to monitor parameters and abnormal information related to voltage sensors, current sensors, temperature sensors, etc., which are used to measure indicators such as electric quantity, temperature, current, and voltage of on-board energy storage batteries.

Herein, the Response Slot Spacing (RSS) refers to an interval distance between a time domain start point of the previous response slot and a time domain start point of the next response slot among two adjacent response slots in the plurality of response slots configured for any subevent in the corresponding subevent set.

The Response Slot Delay (RSD) refers to an interval distance between the time-domain start point of a subevent and the time-domain start point of the first response slot in that subevent, for any subevent of the corresponding subevent set.

In application, the plurality of subevent sets may only comprise the at least two target subevent sets, or may comprise both the at least two target subevent sets and one or more non-target subevent sets. For the non-target subevent sets, the same response slot spacing and the same response slot delay may be adopted.

In the present disclosure, the central device and the plurality of peripheral devices forming the WBMS can establish a point-to-multipoint PAWHR link, and each periodic advertising interval in the PAWHR link comprises at least two target subevent sets. The hierarchical response is implemented by setting different response slot spacings and/or different response slot delays for different target subevent sets among the at least two target subevent sets. This can adapt to variable communication requirements of different response latencies and response data of different lengths, enabling the WBMS to support the hierarchical transmission of battery parameters with different data lengths and different latency requirements while balancing low communication latency and a larger number of accessible terminal nodes.

It should be noted that the bidirectional communication link may also be a Periodic Advertising With Responses (PAWR) link, so as to be compatible with existing public or private link protocols and improve versatility of the solution disclosed in the present disclosure. In some embodiments, when the bidirectional communication link is a PAWR link, according to a BLE PAWR protocol, each periodic advertising interval of the PAWR link comprises a plurality of subevents. In each subevent, the central device first broadcasts a data packet. After a fixed response slot delay, the central device receives response data packets from peripheral devices in sequence within the multiple response slots of the subevent. According to the BLE link protocol, all subevents have the same response slot spacing and the same response slot delay. Therefore, each response slot has identical available slot resources and task scheduling cycle.

In the PAWR protocol, the Auxiliary Advertising (AUX_ADV_IND) Protocol Data Unit (PDU) used by the peripheral devices to synchronize with the central device not only indicates, through its carried Synchronization Information (SyncInfo) field, that the central device transmits PAWR Trains using Auxiliary Synchronization Subevent (AUX_SYNC_SUBEVENT_IND) PDUs and provides synchronization information for PAWR, but also carries Periodic Advertising Response Timing Information (PARTI) in its Additional Controller Advertising Information (ACAD) field to provide additional synchronization information for the PAWR Trains.

Exemplarily, for the PAWHR link in this embodiment, an enable bit may be set in the Auxiliary Advertising PDU to distinguish between the case where the bidirectional communication link is the PAWR link and the case where it is the PAWHR link. The enable bit may be a bit in a Reserved for Future Use (RFU) field of the SyncInfo field of the Auxiliary Advertising PDU.

In this example, the settings may be as follows: when the enable bit is enabled, the bidirectional communication link is the PAWHR link; when the enable bit is not enabled, the bidirectional communication link is a PAWR link.

For example: the enable bit may be set to 0 to indicate that the enable bit is not enabled, and set to 1 to indicate that the enable bit is enabled.

In one embodiment, each peripheral device among the plurality of peripheral devices corresponds to at least one subevent in any one of the target subevent sets, so that the peripheral device can report battery parameters to the central device in at least one response slot of the corresponding subevent.

In this embodiment, based on the above settings, in any target subevent set, at least one subevent is assigned to each peripheral device. This ensures that each peripheral device has at least one opportunity to report the corresponding battery parameters to the central device in each target subevent set, thereby avoiding excessive response latency between some peripheral devices and the central device.

Specifically, in this embodiment, one target subevent set may comprise a plurality of subevents, and one subevent may correspond to one or more peripheral devices.

In this embodiment, a user may pre-group the plurality of peripheral devices into multiple groups according to custom rules, and the peripheral devices in each group correspond to one subevent. For the same peripheral device, the number of corresponding subevents may be the same or different in different target subevent sets. The grouping rules for peripheral devices in different target subevent sets may be the same or different. Therefore, the above-mentioned custom rules are flexibly set by the user according to actual usage requirements, and are not limited in the present disclosure.

In this embodiment, one subevent may be configured with a plurality of response slots, and each response slot is assigned to a different peripheral device. This allows the peripheral device to select, when it needs to report battery parameters to the central device, to send the battery parameters based on the bidirectional communication link within its corresponding response slot. It should be understood that the peripheral devices may also report other information to the central device in the corresponding response slots, which is not specifically limited in the present disclosure. In some embodiments, the corresponding relationship between the peripheral devices and the subevents may be assigned according to each subevent in each target subevent set, the response slot spacing parameter and response slot delay parameter of each target subevent set, and the grouping of peripheral devices. Further, the corresponding relationship between the peripheral devices and the response slots within the subevents may also be assigned. A specific assignment method may be selected according to actual application scenario, and is not limited in the present disclosure.

In one embodiment, the Auxiliary Advertising PDU further comprises: a first parameter for indicating the number of target subevent sets comprised in a periodic advertising interval; a second parameter for indicating the response slot delay of each target subevent set in the periodic advertising interval; a third parameter for indicating the response slot gap of each target subevent set in the periodic advertising interval; and at least two target subevent mapping tables.

Wherein, the at least two target subevent mapping tables are in one-to-one correspondence with the at least two target subevent sets, and the target subevent mapping tables are used to indicate the subevents comprised in the corresponding target subevent sets.

Exemplarily, the target subevent mapping table may be represented in the form of a bit sequence. The bit sequence corresponds to all subevents in the periodic advertising interval, and multiple bits in the bit sequence are arranged from low to high. Each bit in the bit sequence corresponds to the number of one subevent in the periodic advertising interval. If a bit in the bit sequence is set to 1, it means that the corresponding target subevent set comprises the subevent indicated by the bit; if the bit is set to 0, it means that the corresponding target subevent set does not comprise the subevent indicated by the bit.

It should be noted that the aforementioned target subevent mapping table can also be used to indicate distribution of the at least one subevent comprised in the target subevent set within the periodic advertising interval. For example, when the target subevent mapping table is represented in the form of a bit sequence, an association between the multiple subevents and the multiple response slots comprised in the target subevent set can be established by means of forward traversal or reverse traversal of the bit sequence.

For example: assume the bit sequence is [1, 1, 1], where the first bit in the bit sequence refers to a subevent a, the second bit refers to a subevent b, and the third bit refers to a subevent c. If the distribution of these three subevents within the periodic advertising interval is configured by means of forward traversal of the bit sequence, then:

If it is set that the corresponding target subevent set is assigned 3 subevent positions within the periodic advertising interval, the first subevent position assigned to the target subevent set within the periodic advertising interval is associated with the subevent a, the second subevent position is associated with the subevent b, and the third subevent position is associated with the subevent c.

If it is set that the corresponding target subevent set is assigned 4 subevent positions within the periodic advertising interval, the first subevent position assigned to the target subevent set within the periodic advertising interval is associated with the subevent a, the second subevent position is associated with the subevent b, the third subevent position is associated with the subevent c, and the fourth subevent position is associated with the subevent a.

If it is set that the corresponding target subevent set is assigned 6 subevent positions within the periodic advertising interval, the first subevent position assigned to the target subevent set within the periodic advertising interval is associated with the subevent a, the second subevent position is associated with the subevent b, the third subevent position is associated with the subevent c, the fourth subevent position is associated with the subevent a, the fifth subevent position is associated with the subevent b, and the sixth subevent position is associated with the subevent c.

The method of reverse traversal of the bit sequence is similar to that of forward traversal. The difference lies in that the first subevent position assigned to the target subevent set within the periodic advertising interval is associated with the subevent indicated by the last bit in the bit sequence, and so on for subsequent positions. To avoid repetition, further details are not described herein.

Further, when the bidirectional communication link is the Periodic Advertising With Hierarchical Responses (PAWHR) link, an inter-packet interval of the bidirectional communication link is greater than or equal to 40 microseconds, the Response Slot Delay (RSD) is an integer multiple of 0.125 milliseconds, with a range from 0.125 milliseconds to 31.75 milliseconds; the Response Slot Spacing (RSS) is an integer multiple of 0.125 milliseconds, with a range from 0.125 milliseconds to 3.875 milliseconds.

The above settings are used to meet requirements of various response latencies and response data of different lengths that may exist for different peripheral devices.

In one embodiment, when the bidirectional communication link is the PAWHR link, different subevents within the same target subevent set are configured with the same number of response slots.

Further, when the bidirectional communication link is the PAWHR link, the at least two target subevent sets comprise a first target subevent set and a second target subevent set. For any peripheral device among the plurality of peripheral devices, the total number of response slots corresponding to the peripheral device in the first target subevent set is a first total number, and the total number of response slots corresponding to the peripheral device in the second target subevent set is a second total number. The first total number is greater than the second total number.

In a specific embodiment, within the periodic advertising interval, the number of response slots configured in a first subevent is greater than the number of response slots configured in a second subevent, wherein the first subevent is a subevent in the first target subevent set, and the second subevent is a subevent in the second target subevent set.

In this embodiment, based on the above settings, compared with the subevents in the second target subevent set, more response slots are configured in the subevents of the first target subevent set. This creates more data reporting opportunities for the plurality of peripheral devices as a whole, thereby supporting the setting that the first total number corresponding to any peripheral device is greater than the second total number corresponding to that peripheral device.

In another specific embodiment, within the periodic advertising interval, the number of subevents comprised in the first target subevent set is greater than the number of subevents comprised in the second target subevent set.

In this embodiment, based on the above settings, compared with the second target subevent set, more subevents are configured in the first target subevent set. This creates more data reporting opportunities for the plurality of peripheral devices as a whole, thereby supporting the setting that the first total number (of response slots) corresponding to any peripheral device is greater than the second total number (of response slots) corresponding to that peripheral device.

In addition, different custom rules can also be configured to associate a larger number of peripheral devices with the same subevent. Combined with the aforementioned number of response slots and the number of subevents, this can also support the setting that the first total number (of response slots) corresponding to any peripheral device is greater than the second total number (of response slots) corresponding to that peripheral device.

Generally, the battery parameters may comprise multiple types of parameters such as electric quantity, temperature, current, voltage, State of Charge (SOC) of a battery, State of Health (SOH) of the battery, and battery abnormal data. Exemplarily, the battery abnormal data may comprise alarm information indicating excessively low battery power, alarm information indicating excessively high/low battery temperature, alarm information indicating excessively high/low battery current, alarm information indicating excessively high/low battery voltage, alarm information indicating battery aging, and the like.

In this embodiment, the battery parameters can be divided into different levels according to multiple factors such as data length, data type, data importance, and latency characteristics of the battery parameters. Thus, hierarchical transmission can be implemented through multiple target subevent sets. It should be understood that different battery parameters may be classified into the same level or different levels, and specific classification is configured according to an actual application scenario.

In a specific embodiment, the battery parameters comprise first-level parameters and second-level parameters. The first-level parameters comprise battery abnormal data. The second-level parameters comprise at least one of the following: electric quantity, temperature, current, voltage, State of Charge (SOC) of the battery, and State of Health (SOH) of the battery. The response slots in the first target subevent set are at least used for the peripheral devices to report the first-level parameters to the central device based on the bidirectional communication link. The response slots in the second target subevent set are at least used for the peripheral devices to report the second-level parameters to the central device based on the bidirectional communication link.

Without loss of generality, for the same peripheral device, the battery parameters reported by the peripheral device in the response slots corresponding to the first target subevent set have higher requirements on data transmission reliability and/or lower latency requirements, compared with the battery parameters reported by the peripheral device in the response slots corresponding to the second target subevent set.

For example, consider one peripheral device used to monitor battery temperature. This peripheral device not only needs to report a battery temperature to the central device (so that the central device can monitor the battery temperature change accordingly), but also needs to report temperature alarm information to the central device when abnormal battery temperature is detected (e.g., the battery temperature exceeds a set temperature threshold). In this case, the peripheral device can be set to report the battery temperature in the response slots corresponding to the second target subevent set, and report battery temperature abnormal data in the response slots corresponding to the first target subevent set. Since the total number of response slots obtained by the peripheral device in the first target subevent set is greater than that obtained in the second target subevent set, compared with the reporting of battery temperature data in the second target subevent set, the battery temperature abnormal data has more reporting opportunities and lower data reporting latency in the first target subevent set. This further increases probability and speed of the battery temperature abnormal data being successfully received by the Wireless Battery Management Controller (WBMC).

In this embodiment, through the above settings, the peripheral devices can be allocated different numbers of response slots in different target subevent sets, thereby matching different data reporting requirements of the same peripheral device.

Without loss of generality, the communication system of a WBMS based on a PAWHR link is as shown in FIG. 2. The communication system comprises one Wireless Battery Management Controller (WBMC) and a plurality of (N>1) Wireless Cell Supervisor Units (WCSUs). The WBMC and the multiple WCSUs establish a point-to-multipoint bidirectional communication link through the PAWHR protocol to transmit control commands or monitoring data to each other. The WBMC can be understood as the aforementioned central device, and the WCSUs can be understood as the aforementioned peripheral devices. Through the PAWHR link, the WBMC and the multiple WCSUs implement transmission of detection results of battery electric quantity, temperature, current, and voltage, as well as the transmission of battery SOC, SOH monitoring data, and battery abnormal data.

On the basis of the PAWR protocol, the PAWHR protocol described in this application carries Periodic Advertising Hierarchical Response Timing Information (PAHRTI) in the ACAD (Additional Controller Advertising Information) field of the Auxiliary Advertising PDU to provide additional synchronization information for PAWHR Trains.

The PAWHR protocol modifies a bit in a reserved field of the SyncInfo (Synchronization Information) of the AUX_ADV_IND PDU into a PAWHR enable bit (PAWHR_En). PAWHR_En can be set to 0, which indicates that the ACAD carries PARTI (Periodic Advertising Response Timing Information) for PAWR (i.e., indicating that the bidirectional communication link is the PAWR link); PAWHR_En can be set to 1, which indicates that the ACAD carries PAHRTI for PAWHR (i.e., indicating that the bidirectional communication link is the PAWHR link).

The PARTI of the PAWR protocol provides access addresses and time constraints for AUX_SYNC_SUBEVENT_IND PDUs and AUX_SYNC_SUBEVENT_RSP (Auxiliary Synchronization Subevent Response) PDUs through several parameters, including Response Address (RspAA), Number of Subevents (Num of Subevents), Subevent Interval, Response Slot Delay (RSD), and Response Slot Spacing (RSS).

On the basis of PARTI, PAHRTI adds the following parameters:

Number of Subevent Sets (NSBS): indicates the number of subevent sets into which the subevents in one periodic advertising interval are divided, and can be understood as the aforementioned first parameter.

Multiple (NSBS) Response Slot Delays: that is, different numbers of subevent sets correspond to different Response Slot Delays, which are Response Slot Delay 1, Response Slot Delay 2, ..., Response Slot Delay NSBS respectively, and can be understood as the aforementioned second parameter.

Multiple (NSBS) Response Slot Spacings: that is, different numbers of subevent sets correspond to different Response Slot Spacings, which are Response Slot Spacing 1, Response Slot Spacing 2, ..., Response Slot Spacing NSBS respectively, and can be understood as the aforementioned third parameter.

Multiple (NSBS) Mapping Tables of Subevent Sets (MTSBS): that is, indicating which subevents are comprised in each Subevent Set. Each MTSBS contains a number of bits equal to numSubevents (the total number of subevents), where each bit corresponds to one Subevent, and the bit sequence corresponds to the numbers of the Subevents from low to high. If a Subevent Set comprises a certain Subevent, the corresponding bit position is set to 1; otherwise, it is set to 0. The multiple (NSBS) Mapping Tables of the Subevent Sets are MTSBS 1, MTSBS 2, ..., MTSBS NSBS respectively, and can be understood as the aforementioned at least two target subevent mapping tables.

For ease of understanding, an illustrative example is provided as follows: the communication method of the WBMS described in this application is illustrated by taking the power battery management system of an electric vehicle as an example. In the WBMS communication system based on the PAWHR link shown in FIG. 2, the number of WCSUs (N) is 64. The Number of Subevent Sets (NSBS) is 2. The first Subevent Set divides the WCSUs into 8 groups, with 8 WCSUs in each group. The second Subevent Set divides the WCSUs into 2 groups, with 32 WCSUs in each group.

FIG. 3 shows a PAWHR time slot diagram. The Periodic Advertising Interval (PA Interval) is 82.5ms, comprising 16 Subevents, the Subevent Interval is 5ms, occupying a total of 80ms. The remaining 2.5ms is used for transmitting ADV_EXT_IND (Extended Advertising Indication) PDUs and AUX_ADV_IND PDUs for synchronization, as well as for other tasks, e.g., the WBMC establishes a temporary BLE ACL link with the WCSU for configuration parameters, etc.

The 16 Subevents are divided into two Subevent Sets: the first Subevent Set (SBS) consists of 8 Subevents, and the second Subevent Set consists of the other 8 Subevents. In the PAWHR time slot diagram shown in FIG. 3, SBS11, SBS12, SBS13, ..., SBS18 form the first Subevent Set, and SBS21 and SBS22 repeated 4 times form the second Subevent Set. The PAWHR_En in the SyncInfo of the AUX_ADV_IND PDU is set to 1, indicating that its ACAD carries PAHRTI for PAWHR. The values of the Mapping Tables of Subevent Sets (MTSBS) in the PAHRTI carried in the ACAD field of the AUX_ADV_IND PDU are 0x5555 for MTSBS 1, and 0xAAAA for MTSBS 2.

FIG. 4 shows PAWHR Subevent time slot diagrams, where FIG. 4(a) is the time slot diagram of Subevents in the first Subevent Set, and FIG. 4(b) is the time slot diagram of Subevents in the second Subevent Set. "C" represents the time slot in which the central device transmits AUX_SYNC_SUBEVENT_IND PDUs, and "P" represents the response slots of the peripheral devices, i.e., the time slots in which AUX_SYNC_SUBEVENT_RSP PDUs are transmitted.

As shown in FIG. 4(a): Response Slot Delay 1 is 8, and corresponding time is 1 ms); Response Slot Spacing 1 is 4, and corresponding time is 0.5 ms. Each Subevent in the first Subevent Set contains 8 Response Slots, and can transmit a maximum of 8 AUX_SYNC_SUBEVENT_RSP PDUs.

As shown in FIG. 4(b): Response Slot Delay 2 is 8, and corresponding time is 1 ms; Response Slot Spacing 2 is 1, and corresponding time is 0.125 ms. Each Subevent in the second Subevent Set contains 32 Response Slots, and can transmit a maximum of 32 AUX_SYNC_SUBEVENT_RSP PDUs.

In the first Subevent Set: AUX_SYNC_SUBEVENT_IND PDUs are transmitted using the BLE 2 Mbps Physical Layer (PHY), which can transmit a maximum of 224 encrypted bytes. In each Response Slot, AUX_SYNC_SUBEVENT_RSP PDUs are transmitted using the BLE 2 Mbps PHY, which can transmit a maximum of 100 encrypted bytes, wherein T_IFS = 40 μs.

In the second Subevent Set: AUX_SYNC_SUBEVENT_IND PDUs are transmitted using the BLE 2 Mbps PHY, which can transmit a maximum of 224 encrypted bytes. In each Response Slot, AUX_SYNC_SUBEVENT_RSP PDUs are transmitted using the BLE 2 Mbps PHY, which can transmit a maximum of 6 encrypted bytes, wherein T_IFS = 41 μs.

In this example, the Subevents in the first Subevent Set are used by WCSUs to transmit regular parameters (e.g., electric quantity, temperature, current, voltage, SOC, and SOH). Each WCSU is allocated at least one Response Slot in one Subevent of the first Subevent Set for transmitting one or more of the aforementioned regular parameters. The 64 WCSUs can be divided into 8 groups according to preset rules, corresponding to 8 Subevents respectively. Each group of 8 WCSUs corresponds to 8 Response Slots in the corresponding Subevent. The preset rules can be understood as the aforementioned custom rules, which are specifically determined by the user (in this example, the electric vehicle manufacturer).

The Subevents in the second Subevent Set are used by WCSUs to transmit emergency signals (e.g., alarm information indicating that any of the parameters such as electric quantity, temperature, current, voltage, SOC, and SOH exceeds a warning threshold). Specifically, each emergency signal is represented by at least 1 bit (0 indicates a non-emergency abnormality, and 1 indicates an emergency abnormality). Each WCSU is allocated at least one Response Slot in one Subevent of the second Subevent Set for transmitting the aforementioned emergency signals. The 64 WCSUs can be divided into 2 groups according to preset rules, corresponding to 2 Subevents respectively. Each group of 32 WCSUs corresponds to 32 Response Slots in the corresponding Subevent. Within one periodic advertising interval, the second Subevent Set is repeated 4 times, meaning each WCSU has 4 transmission opportunities. This greatly reduces the latency of emergency signal transmission and improves the reliability of emergency signal transmission.

In addition, the application data in the AUX_SYNC_SUBEVENT_IND PDUs is also determined by the user, including WCSU configuration parameters and the like.

In summary, the application based on the PAWHR protocol can support the WCSUs in the WBMS to adopt different task scheduling cycles and different response times, so as to meet the requirements of various response latencies and response data of different lengths.

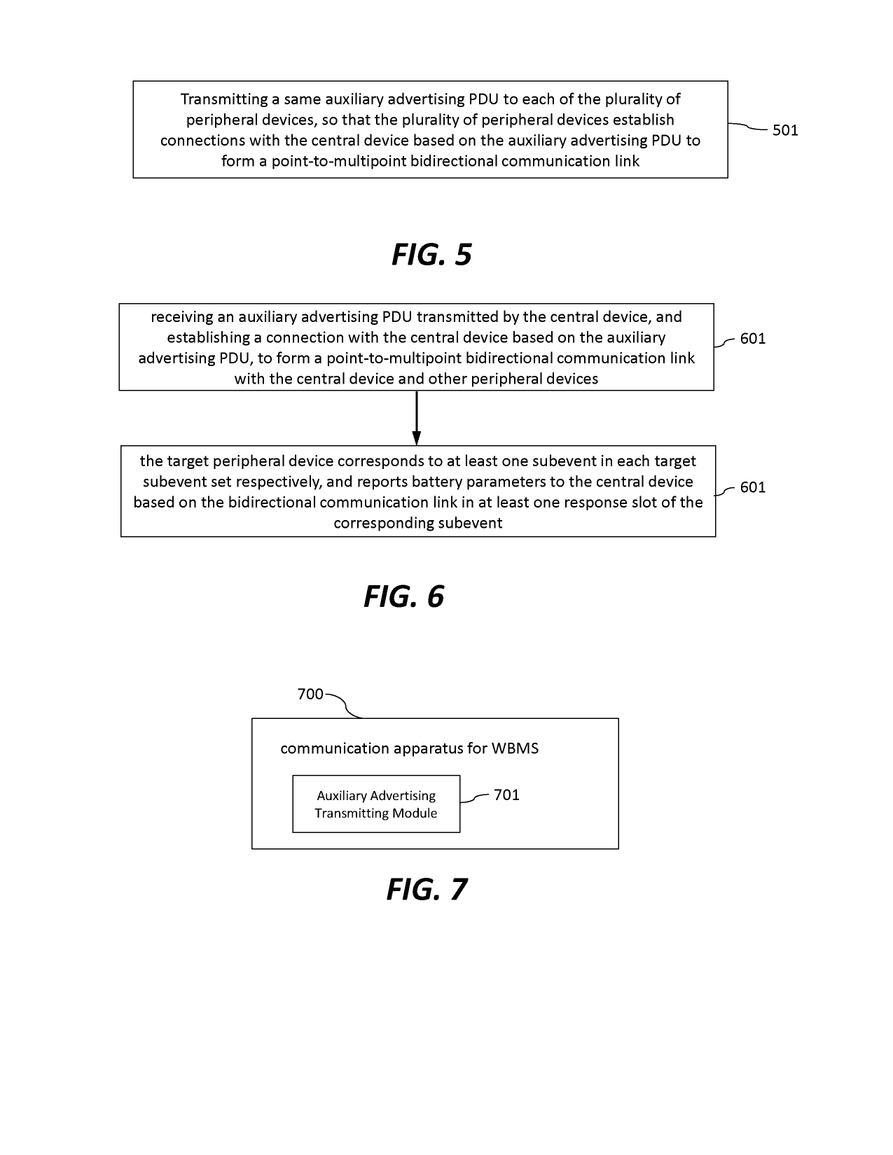

A communication method for a WBMS is provided according to one embodiment of the present disclosure. The WBMS comprises one central device and a plurality of peripheral devices, and the communication method is applied to the central device. As shown in FIG. 5, the communication method comprises the following operations.

At 501: the central device transmits a same auxiliary advertising PDU to the plurality of peripheral devices respectively, so that the plurality of peripheral devices establish connections with the central device based on the auxiliary advertising PDU to form a point-to-multipoint bidirectional communication link.

Wherein, when the bidirectional communication link is a Periodic Advertising With Hierarchical Responses (PAWHR) link, each periodic advertising interval in the bidirectional communication link comprises a plurality of subevent sets, and the plurality of subevent sets comprise at least two target subevent sets. Each target subevent set contains at least one subevent, and each subevent is configured with a plurality of response slots. Among the at least two target subevent sets, the response slot spacings of different target subevent sets are different, and/or the response slot delays of different target subevent sets are different. The response slots are at least used for the central device to receive the battery parameters reported by the peripheral devices to the central device based on the bidirectional communication link.

In one embodiment, among the plurality of peripheral devices, each peripheral device corresponds to at least one subevent in any one of the target subevent sets, so that the peripheral device can report battery parameters to the central device in at least one response slot of the corresponding subevent.

In one embodiment, the Auxiliary Advertising PDU comprises an enable bit. When the enable bit is enabled, the bidirectional communication link is the PAWHR link. When the enable bit is not enabled, the bidirectional communication link is a Periodic Advertising With Responses (PAWR) link.

In one embodiment, the Auxiliary Advertising PDU comprises: a first parameter for indicating the number of target subevent sets comprised in a periodic advertising interval; a second parameter for indicating the response slot delay of each target subevent set in the periodic advertising interval; a third parameter for indicating the response slot spacing of each target subevent set in the periodic advertising interval; and at least two target subevent mapping tables. Wherein the at least two target subevent mapping tables correspond one-to-one to the at least two target subevent sets, and one target subevent mapping table is used to indicate the subevents comprised in the corresponding target subevent set.

In one embodiment, when the bidirectional communication link is the PAWHR link, different subevents in the same target subevent set are configured with the same number of response slots.

In one embodiment, when the bidirectional communication link is the PAWHR link, the at least two target subevent sets comprise a first target subevent set and a second target subevent set. For any peripheral device among the plurality of peripheral devices, the total number of response slots corresponding to the peripheral device in the first target subevent set is a first total number, and the total number of response slots corresponding to the peripheral device in the second target subevent set is a second total number. The first total number is greater than the second total number.

In one embodiment, within the periodic advertising interval, the number of subevents comprised in the first target subevent set is greater than the number of subevents comprised in the second target subevent set.

In one embodiment, within the periodic advertising interval, the number of response slots configured in a first subevent is greater than the number of response slots configured in a second subevent, where the first subevent is a subevent in the first target subevent set, and the second subevent is a subevent in the second target subevent set.

In one embodiment, the battery parameters comprise first-level parameters and second-level parameters. The first-level parameters comprise battery abnormal data. The second-level parameters comprise at least one of the following: electric quantity, temperature, current, voltage, State of Charge (SOC) of the battery, and State of Health (SOH) of the battery. The response slots in the first target subevent set are at least used for the peripheral devices to report the first-level parameters to the central device based on the bidirectional communication link. The response slots in the second target subevent set are at least used for the peripheral devices to report the second-level parameters to the central device based on the bidirectional communication link.

In one embodiment, when the bidirectional communication link is the PAWHR link, an inter-frame space of the bidirectional communication link is greater than or equal to 40 microseconds; the response slot delay is an integer multiple of 0.125 milliseconds, with a range from 0.125 milliseconds to 31.75 milliseconds; the response slot spacing is an integer multiple of 0.125 milliseconds, with a range from 0.125 milliseconds to 3.875 milliseconds.

This communication method for the WBMS provided according to one embodiment of the present disclosure corresponds to each process related to the central device in the aforementioned embodiments and can achieve the same technical effects. To avoid repetition, details are not described herein again.

A communication method for a WBMS is provided according to one embodiment of the present disclosure. The WBMS comprises one central device and a plurality of peripheral devices, and the communication method is applied to a target peripheral device, wherein the target peripheral device is one of the plurality of peripheral devices. As shown in FIG. 6, the communication method comprises the following operations.

At 601: the target peripheral device receives an auxiliary advertising PDU transmitted by the central device, and establishes a connection with the central device based on the auxiliary advertising PDU, to form a point-to-multipoint bidirectional communication link with the central device and other peripheral devices.

Wherein, when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots. Among the at least two target subevent sets, response slot spacings of different target subevent sets are different, and/or response slot delays of different target subevent sets are different.

At 602: the target peripheral device corresponds to at least one subevent in each target subevent set respectively, and reports battery parameters to the central device based on the bidirectional communication link in at least one response slot of the corresponding subevent.

In one embodiment, among the plurality of peripheral devices, each peripheral device corresponds to at least one subevent in any one of the target subevent sets, so that the peripheral device can report battery parameters to the central device in at least one response slot of the corresponding subevent.

In one embodiment, the Auxiliary Advertising PDU comprises an enable bit. When the enable bit is enabled, the bidirectional communication link is a PAWHR link. When the enable bit is not enabled, the bidirectional communication link is a Periodic Advertising With Responses (PAWR) link.

In one embodiment, the Auxiliary Advertising PDU comprises: a first parameter for indicating the number of target subevent sets comprised in a periodic advertising interval; a second parameter for indicating the response slot delay of each target subevent set in the periodic advertising interval; a third parameter for indicating the response slot spacing of each target subevent set in the periodic advertising interval; and at least two target subevent mapping tables; wherein the at least two target subevent mapping tables correspond one-to-one to the at least two target subevent sets, and one target subevent mapping table is used to indicate the subevents comprised in the corresponding target subevent set.

In one embodiment, when the bidirectional communication link is the periodic advertising with hierarchical responses link, different subevents in the same target subevent set are configured with the same number of response slots.

In one embodiment, when the bidirectional communication link is the PAWHR link, the at least two target subevent sets comprise a first target subevent set and a second target subevent set. For any peripheral device among the plurality of peripheral devices, the total number of response slots corresponding to the peripheral device in the first target subevent set is a first total number, and the total number of response slots corresponding to the peripheral device in the second target subevent set is a second total number. The first total number is greater than the second total number.

In one embodiment, within the periodic advertising interval, the number of subevents comprised in the first target subevent set is greater than the number of subevents comprised in the second target subevent set.

In one embodiment, within the periodic advertising interval, the number of response slots configured in a first subevent is greater than the number of response slots configured in a second subevent, where the first subevent is a subevent in the first target subevent set, and the second subevent is a subevent in the second target subevent set.

In one embodiment, the battery parameters comprise first-level parameters and second-level parameters. The first-level parameters comprise battery abnormal data. The second-level parameters comprise at least one of the following: electric quantity, temperature, current, voltage, State of Charge (SOC) of the battery, and State of Health (SOH) of the battery. The response slots in the first target subevent set are at least used for the peripheral devices to report the first-level parameters to the central device based on the bidirectional communication link. The response slots in the second target subevent set are at least used for the peripheral devices to report the second-level parameters to the central device based on the bidirectional communication link.

In one embodiment, when the bidirectional communication link is the PAWHR link: an inter-frame space of the bidirectional communication link is greater than or equal to 40 microseconds; the response slot delay is an integer multiple of 0.125 milliseconds, with a range from 0.125 milliseconds to 31.75 milliseconds; the response slot spacing is an integer multiple of 0.125 milliseconds, with a range from 0.125 milliseconds to 3.875 milliseconds.

This communication method for the WBMS provided according to one embodiment of the present disclosure corresponds to each process related to the peripheral device in the aforementioned embodiments and can achieve the same technical effects. To avoid repetition, details are not described herein again.

One embodiment of the present disclosure further provides a communication apparatus for a WBMS. The WBMS comprises one central device and a plurality of peripheral devices, and the communication apparatus is applied to the central device. As shown in FIG. 7, the communication apparatus 700 comprises: an Auxiliary Advertising Transmitting Module 701, configured to transmit the same Auxiliary Advertising PDU to each of the plurality of peripheral devices, so that the plurality of peripheral devices establish connections with the central device based on the Auxiliary Advertising PDU to form a point-to-multipoint bidirectional communication link.

Wherein, when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots. Among the at least two target subevent sets, response slot spacings of different target subevent sets are different, and/or response slot delays of different target subevent sets are different.

The response slots are at least used for the central device to receive the battery parameters reported by the peripheral devices to the central device based on the bidirectional communication link.

In one embodiment, among the plurality of peripheral devices, each peripheral device corresponds to at least one subevent in any one of the target subevent sets, so that the peripheral device can report battery parameters to the central device in at least one response slot of the corresponding subevent.

In one embodiment, the Auxiliary Advertising PDU comprises an enable bit. When the enable bit is enabled, the bidirectional communication link is the PAWHR link. When the enable bit is not enabled, the bidirectional communication link is a Periodic Advertising With Responses (PAWR) link.

In one embodiment, the Auxiliary Advertising PDU comprises: a first parameter for indicating the number of target subevent sets comprised in a periodic advertising interval; a second parameter for indicating the response slot delay of each target subevent set in the periodic advertising interval; a third parameter for indicating the response slot spacing of each target subevent set in the periodic advertising interval; and at least two target subevent mapping tables. Wherein the at least two target subevent mapping tables correspond one-to-one to the at least two target subevent sets, and one target subevent mapping table is used to indicate the subevents comprised in the corresponding target subevent set.

In one embodiment, when the bidirectional communication link is the PAWHR link, different subevents in the same target subevent set are configured with the same number of response slots.

In one embodiment, when the bidirectional communication link is the PAWHR link, the at least two target subevent sets comprise a first target subevent set and a second target subevent set. For any peripheral device among the plurality of peripheral devices, the total number of response slots corresponding to the peripheral device in the first target subevent set is a first total number, and the total number of response slots corresponding to the peripheral device in the second target subevent set is a second total number. The first total number is greater than the second total number.

In one embodiment, within the periodic advertising interval, the number of subevents comprised in the first target subevent set is greater than the number of subevents comprised in the second target subevent set.

In one embodiment, within the periodic advertising interval, the number of response slots configured in a first subevent is greater than the number of response slots configured in a second subevent, where the first subevent is a subevent in the first target subevent set, and the second subevent is a subevent in the second target subevent set.

In one embodiment, the battery parameters comprise first-level parameters and second-level parameters. The first-level parameters comprise battery abnormal data. The second-level parameters comprise at least one of the following: electric quantity, temperature, current, voltage, State of Charge (SOC) of the battery, and State of Health (SOH) of the battery. The response slots in the first target subevent set are at least used for the peripheral devices to report the first-level parameters to the central device based on the bidirectional communication link. The response slots in the second target subevent set are at least used for the peripheral devices to report the second-level parameters to the central device based on the bidirectional communication link.

In one embodiment, when the bidirectional communication link is the PAWHR link, an inter-frame space of the bidirectional communication link is greater than or equal to 40 microseconds; the response slot delay is an integer multiple of 0.125 milliseconds, with a range from 0.125 milliseconds to 31.75 milliseconds; the response slot spacing is an integer multiple of 0.125 milliseconds, with a range from 0.125 milliseconds to 3.875 milliseconds.

The communication apparatus 700 for the WBMS provided by the embodiment of the present disclosure corresponds to each process of the communication method on the central device side in the aforementioned embodiments and can achieve the same technical effects. To avoid repetition, details are not described herein again.

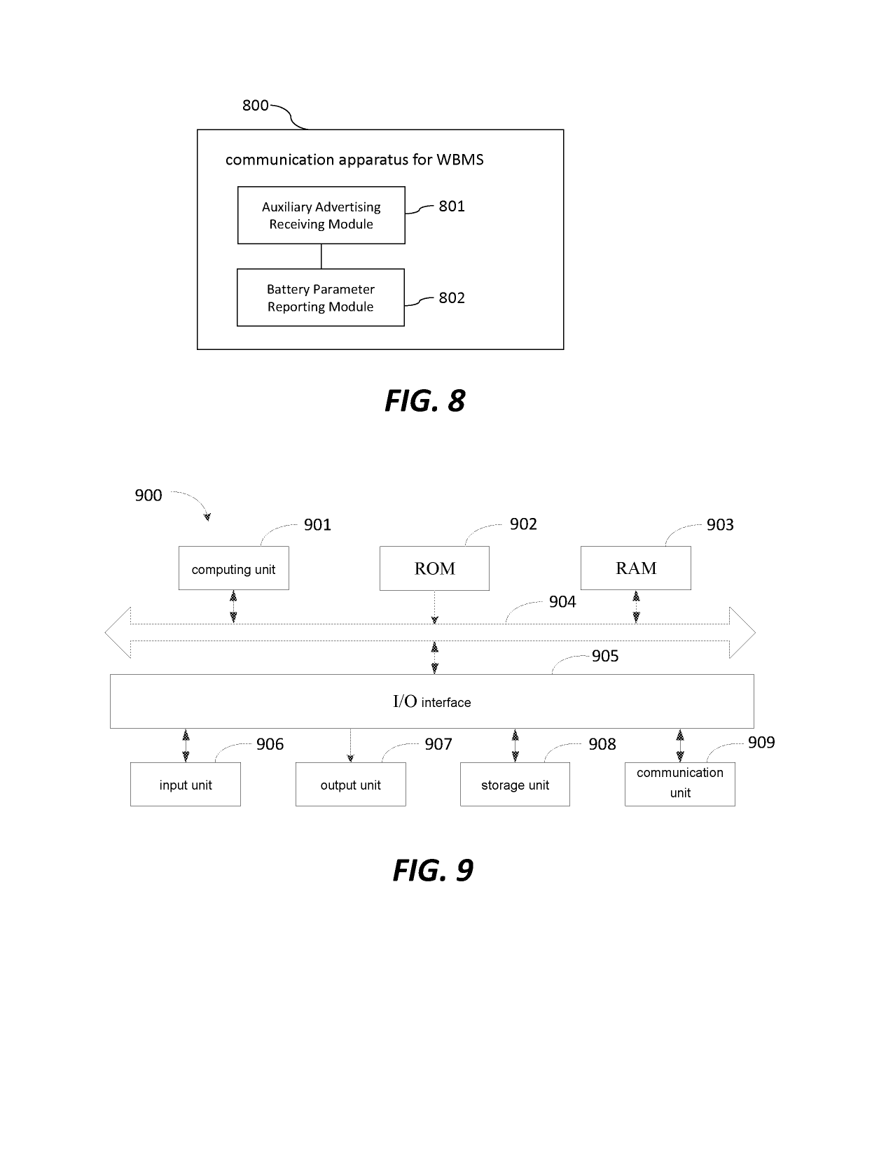

A communication apparatus for a WBMS is provided according to one embodiment of the present disclosure. The WBMS comprises one central device and a plurality of peripheral devices, and the communication apparatus is applied to a target peripheral device, where the target peripheral device is one of the plurality of peripheral devices. As shown in FIG. 8, the communication apparatus 800 comprises: an Auxiliary Advertising Receiving Module 801, configured to receive an Auxiliary Advertising PDU sent by the central device, and establish a connection with the central device based on the Auxiliary Advertising PDU to form a point-to-multipoint bidirectional communication link with the central device and other peripheral devices; and a Battery Parameter Reporting Module 802, configured to enable the target peripheral device to report battery parameters to the central device based on the bidirectional communication link in at least one response slot of the corresponding subevent.

Wherein, when the bidirectional communication link is a Periodic Advertising With Hierarchical Responses (PAWHR) link, each periodic advertising interval in the bidirectional communication link comprises a plurality of subevent sets, and the plurality of subevent sets comprise at least two target subevent sets. Each target subevent set contains at least one subevent, and each subevent is configured with a plurality of response slots; the target peripheral device corresponds to at least one subevent in each target subevent set respectively; among the at least two target subevent sets, the response slot spacings of different target subevent sets are different, and/or the response slot delays of different target subevent sets are different.

In one embodiment, among the plurality of peripheral devices, each peripheral device corresponds to at least one subevent in any one of the target subevent sets, so that the peripheral device can report battery parameters to the central device in at least one response slot of the corresponding subevent.

In one embodiment, the Auxiliary Advertising PDU comprises an enable bit. When the enable bit is enabled, the bidirectional communication link is the PAWHR link. When the enable bit is not enabled, the bidirectional communication link is a Periodic Advertising With Responses (PAWR) link.

In one embodiment, the Auxiliary Advertising PDU comprises: a first parameter for indicating the number of target subevent sets comprised in a periodic advertising interval; a second parameter for indicating the response slot delay of each target subevent set in the periodic advertising interval; a third parameter for indicating the response slot spacing of each target subevent set in the periodic advertising interval; and at least two target subevent mapping tables. Wherein the at least two target subevent mapping tables correspond one-to-one to the at least two target subevent sets, and one target subevent mapping table is used to indicate the subevents comprised in the corresponding target subevent set.

In one embodiment, when the bidirectional communication link is the PAWHR link, different subevents in the same target subevent set are configured with the same number of response slots.

In one embodiment, when the bidirectional communication link is the PAWHR link, the at least two target subevent sets comprise a first target subevent set and a second target subevent set. For any peripheral device among the plurality of peripheral devices, the total number of response slots corresponding to the peripheral device in the first target subevent set is a first total number, and the total number of response slots corresponding to the peripheral device in the second target subevent set is a second total number. The first total number is greater than the second total number.

In one embodiment, within the periodic advertising interval, the number of subevents comprised in the first target subevent set is greater than the number of subevents comprised in the second target subevent set.

In one embodiment, within the periodic advertising interval, the number of response slots configured in a first subevent is greater than the number of response slots configured in a second subevent, where the first subevent is a subevent in the first target subevent set, and the second subevent is a subevent in the second target subevent set.

In one embodiment, the battery parameters comprise first-level parameters and second-level parameters. The first-level parameters comprise battery abnormal data. The second-level parameters comprise at least one of the following: electric quantity, temperature, current, voltage, State of Charge (SOC) of the battery, and State of Health (SOH) of the battery. The response slots in the first target subevent set are at least used for the peripheral devices to report the first-level parameters to the central device based on the bidirectional communication link. The response slots in the second target subevent set are at least used for the peripheral devices to report the second-level parameters to the central device based on the bidirectional communication link.

In one embodiment, when the bidirectional communication link is the PAWHR link, an inter-frame space of the bidirectional communication link is greater than or equal to 40 microseconds; the response slot delay is an integer multiple of 0.125 milliseconds, with a range from 0.125 milliseconds to 31.75 milliseconds; the response slot spacing is an integer multiple of 0.125 milliseconds, with a range from 0.125 milliseconds to 3.875 milliseconds.

The communication apparatus 800 for the WBMS provided by the embodiment of the present disclosure corresponds to each process of the communication method on the peripheral device side in the aforementioned embodiments and can achieve the same technical effects. To avoid repetition, details are not described herein again.

According to the embodiments of the present disclosure, the present disclosure further provides an electronic device and a readable storage medium.

FIG. 9 shows a schematic block diagram of an exemplary electronic device 900 that can be used to implement the embodiments of the present disclosure. As shown in FIG. 9, the device 900 comprises a computing unit 901, which can execute various appropriate actions and processes according to a computer program stored in a Read-Only Memory (ROM) 902 or a computer program loaded into a Random Access Memory (RAM) 903 from a storage unit 908. In the RAM 903, various programs and data required for the operation of the device 900 can also be stored. The computing unit 901, the ROM 902, and the RAM 903 are connected to each other through a bus 904. An Input/Output (I/O) interface 905 is also connected to the bus 904.

A plurality of components in the device 900 are connected to the I/O interface 905, including: an input unit 906 (such as a keyboard, a mouse, etc.); an output unit 907 (such as various types of displays, speakers, etc.); a storage unit 908 (such as a magnetic disk, an optical disk, etc.); and a communication unit 909 (such as a network card, a modem, a wireless communication transceiver, etc.). The communication unit 909 enables the device 900 to exchange information/data with other devices through a computer network such as the Internet and/or various telecommunication networks.

The computing unit 901 may be various general-purpose and/or special-purpose processing components with processing and computing capabilities. Examples of the computing unit 901 include, but are not limited to, a Central Processing Unit (CPU), a Graphic Processing Unit (GPU), various dedicated Artificial Intelligence (AI) computing chips, various computing units running machine learning model algorithms, a Digital Signal Processor (DSP), and any appropriate processor, controller, microcontroller, etc. The computing unit 901 executes the various methods and processes described above, such as the communication method for the WBMS. For example, in some embodiments, the communication method for the WBMS may be implemented as a computer software program, which is tangibly embodied in a machine-readable medium such as the storage unit 908. In some embodiments, part or all of the computer programs may be loaded into and/or installed on the device 900 via the ROM 902 and/or the communication unit 909. When the computer program is loaded into the RAM 903 and executed by the computing unit 901, one or more steps of the communication method for the WBMS described above may be executed. Alternatively, in other embodiments, the computing unit 901 may be configured to execute the communication method for the WBMS in any other appropriate manner (for example, by means of firmware).

Various implementations of the systems and technologies described herein may be implemented in digital electronic circuit systems, integrated circuit systems, Field-Programmable Gate Arrays (FPGAs), Application Specific Integrated Circuits (ASICs), Application Specific Standard Products (ASSPs), System on Chips (SOCs), Complex Programmable Logic Devices (CPLDs), computer hardware, firmware, software, and/or combinations thereof. These various implementations may include: being implemented in one or more computer programs that can be executed and/or interpreted on a programmable system including at least one programmable processor. The programmable processor may be a dedicated or general-purpose programmable processor, and can receive data and instructions from a storage system, at least one input device, and at least one output device, and transmit data and instructions to the storage system, the at least one input device, and the at least one output device.

One embodiment of the present disclosure further provides a computer-readable storage medium. The method according to the embodiments of the present disclosure may be implemented in hardware, firmware, or implemented as computer code that can be recorded in a storage medium, or implemented as computer code that is originally stored in a remote storage medium or a non-transitory machine-readable storage medium and downloaded through a network to be stored in a local storage medium. Thus, the method described herein may be stored as such software processing on a storage medium using a general-purpose computer, a dedicated processor, or programmable or dedicated hardware. The storage medium may be a magnetic disk, an optical disk, a read-only memory (ROM), a random access memory (RAM), a flash memory, a hard disk, a solid-state drive, or the like; further, the storage medium may also comprise a combination of the aforementioned types of memories. It can be understood that a computer, a processor, a microprocessor controller, or programmable hardware comprises a storage component that can store or receive software or computer code. When the software or computer code is accessed and executed by the computer, the processor, or the hardware, the method shown in the aforementioned embodiments is implemented.

The embodiments of the present disclosure are described above in conjunction with the accompanying drawings, but the present disclosure is not limited to the specific embodiments described above, the specific embodiments described above are merely illustrative and not limiting, and the person of ordinary skill in the field of the present disclosure, without departing from the purpose of the application and the scope of protection of the claims, may also make many forms, all of which are under the protection of the present disclosure.

Although preferred embodiments of the present disclosure have been described, additional changes and modifications to these embodiments may be made once the basic creative concepts are known to those skilled in the art. The appended claims are therefore intended to be interpreted to comprise preferred embodiments and all changes and modifications falling within the scope of the present disclosure.

A person skilled in the art may make various changes and variations to the application without departing from the spirit and scope of the application. Thus, if these modifications and variations of the present disclosure fall within the scope of the claims and their equivalent technologies, the disclosure is also intended to comprise these changes and variations.

What is claimed is:

1. A communication method for a wireless battery management system comprising a central device and a plurality of peripheral devices, comprising:
transmitting, by the central device, a same auxiliary advertising PDU to each of the plurality of peripheral devices, so that the plurality of peripheral devices establish connections with the central device based on the auxiliary advertising PDU to form a point-to-multipoint bidirectional communication link;
wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots;
among the at least two target subevent sets, response slot spacings of different target subevent sets are different, and/or response slot delays of different target subevent sets are different; and
the response slots are at least used for the peripheral devices to report battery parameters to the central device based on the bidirectional communication link.

2. The communication method according to claim 1, wherein among the plurality of peripheral devices, each peripheral device corresponds to at least one subevent in any one of the target subevent sets, so that the peripheral device can report battery parameters to the central device in at least one response slot of the corresponding subevent.

3. The communication method according to claim 1, wherein the auxiliary advertising PDU comprises an enable bit;
when the enable bit is enabled, the bidirectional communication link is the periodic advertising with hierarchical responses link;
when the enable bit is not enabled, the bidirectional communication link is a periodic advertising with responses link.

4. The communication method according to claim 1, wherein the auxiliary advertising PDU comprises:
a first parameter for indicating the number of target subevent sets comprised in a periodic advertising interval;
a second parameter for indicating the response slot delay of each target subevent set in the periodic advertising interval;
a third parameter for indicating the response slot spacing of each target subevent set in the periodic advertising interval; and
at least two target subevent mapping tables;
wherein the at least two target subevent mapping tables correspond one-to-one to the at least two target subevent sets, and one target subevent mapping table is used to indicate the subevents comprised in the corresponding target subevent set.

5. The communication method according to claim 1, wherein when the bidirectional communication link is the periodic advertising with hierarchical responses link, different subevents in the same target subevent set are configured with the same number of response slots.

6. The communication method according to claim 5, wherein when the bidirectional communication link is the periodic advertising with hierarchical responses link, the at least two target subevent sets comprise a first target subevent set and a second target subevent set;
for any peripheral device among the plurality of peripheral devices, the total number of response slots corresponding to the peripheral device in the first target subevent set is a first total number, and the total number of response slots corresponding to the peripheral device in the second target subevent set is a second total number;
the first total number is greater than the second total number.

7. The communication method according to claim 6, wherein within the periodic advertising interval, the number of subevents comprised in the first target subevent set is greater than the number of subevents comprised in the second target subevent set.

8. The communication method according to claim 6, wherein within the periodic advertising interval, the number of response slots configured in a first subevent is greater than the number of response slots configured in a second subevent, wherein the first subevent is a subevent within the first target subevent set, and the second subevent is a subevent within the second target subevent set.

9. The communication method according to claim 1, wherein, the battery parameters comprise first-level parameters and second-level parameters,
the first-level parameters comprise battery abnormal data;
the second-level parameters comprise at least one of electric quantity, temperature, current, voltage, State of Charge (SOC), State of Health (SOH);
the response slots in the first target subevent set are at least used for the peripheral devices to report the first-level parameters to the central device based on the bidirectional communication link;
the response slots in the second target subevent set are at least used for the peripheral devices to report the second-level parameters to the central device based on the bidirectional communication link.

10. The communication method according to claim 1, wherein when the bidirectional communication link is the periodic advertising with hierarchical responses link:
an inter-frame space of the bidirectional communication link is greater than or equal to 40 microseconds;
the response slot delay is an integer multiple of 0.125 milliseconds, with a range from 0.125 milliseconds to 31.75 milliseconds;
the response slot spacing is an integer multiple of 0.125 milliseconds, with a range from 0.125 milliseconds to 3.875 milliseconds.

11. A communication method for a wireless battery management system comprising a central device and a plurality of peripheral devices, applied to the central device, the method comprising:
transmitting a same auxiliary advertising PDU to the plurality of peripheral devices respectively, so that the plurality of peripheral devices establish connections with the central device based on the auxiliary advertising PDU to form a point-to-multipoint bidirectional communication link;
wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots;
among the at least two target subevent sets, response slot spacings of different target subevent sets are different, and/or response slot delays of different target subevent sets are different; and
the response slots are at least used for the central device to receive battery parameters reported by the peripheral devices based on the bidirectional communication link.

12. The communication method according to claim 11, wherein among the plurality of peripheral devices, each peripheral device corresponds to at least one subevent in any one of the target subevent sets, so that the peripheral device can report battery parameters to the central device in at least one response slot of the corresponding subevent.

13. The communication method according to claim 11, wherein the auxiliary advertising PDU comprises an enable bit;
when the enable bit is enabled, the bidirectional communication link is the periodic advertising with hierarchical responses link;
when the enable bit is not enabled, the bidirectional communication link is a periodic advertising with responses link.

14. The communication method according to claim 11, wherein the auxiliary advertising PDU comprises:
a first parameter for indicating the number of target subevent sets comprised in a periodic advertising interval;
a second parameter for indicating the response slot delay of each target subevent set in the periodic advertising interval;
a third parameter for indicating the response slot spacing of each target subevent set in the periodic advertising interval; and
at least two target subevent mapping tables;
wherein the at least two target subevent mapping tables correspond one-to-one to the at least two target subevent sets, and one target subevent mapping table is used to indicate the subevents comprised in the corresponding target subevent set.

15. A communication method for a wireless battery management system comprising a central device and a plurality of peripheral devices, applied to a target peripheral device being one peripheral device among the plurality of peripheral devices, comprising:
receiving an auxiliary advertising PDU transmitted by the central device, and establishing a connection with the central device based on the auxiliary advertising PDU, to form a point-to-multipoint bidirectional communication link with the central device;
wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots;
among the at least two target subevent sets, response slot spacings of different target subevent sets are different, and/or response slot delays of different target subevent sets are different; and
the target peripheral device corresponds to at least one subevent in each target subevent set respectively, and reports battery parameters to the central device based on the bidirectional communication link in at least one response slot of the corresponding subevent.

16. The communication method according to claim 15, wherein among the plurality of peripheral devices, each peripheral device corresponds to at least one subevent in any one of the target subevent sets, so that the peripheral device can report battery parameters to the central device in at least one response slot of the corresponding subevent.

17. The communication method according to claim 15, wherein the auxiliary advertising PDU comprises an enable bit;
when the enable bit is enabled, the bidirectional communication link is the periodic advertising with hierarchical responses link;
when the enable bit is not enabled, the bidirectional communication link is a periodic advertising with responses link.

18. The communication method according to claim 15, wherein the auxiliary advertising PDU comprises:
a first parameter for indicating the number of target subevent sets comprised in a periodic advertising interval;
a second parameter for indicating the response slot delay of each target subevent set in the periodic advertising interval;
a third parameter for indicating the response slot spacing of each target subevent set in the periodic advertising interval; and
at least two target subevent mapping tables;
wherein the at least two target subevent mapping tables correspond one-to-one to the at least two target subevent sets, and one target subevent mapping table is used to indicate the subevents comprised in the corresponding target subevent set.

19. A communication apparatus for a wireless battery management system comprising a central device and a plurality of peripheral devices, applied to the central device, comprising:
an Auxiliary Advertising Transmitting Module, configured to transmit a same auxiliary advertising PDU to the plurality of peripheral devices respectively, so that the plurality of peripheral devices establish connections with the central device based on the auxiliary advertising PDU to form a point-to-multipoint bidirectional communication link;
wherein when the bidirectional communication link is a periodic advertising with hierarchical responses link, each periodic advertising interval in the bidirectional communication link comprises a plurality of subevent sets, the plurality of subevent sets comprise at least two target subevent sets, each target subevent set comprises at least one subevent, each subevent is configured with a plurality of response slots;
among the at least two target subevent sets, response slot spacings of different target subevent sets are different, and/or response slot delays of different target subevent sets are different; and
the response slots are at least used for the central device to receive battery parameters reported by the peripheral devices to the central device based on the bidirectional communication link.

20. The communication apparatus according to claim 15, wherein among the plurality of peripheral devices, each peripheral device corresponds to at least one subevent in any one of the target subevent sets, so that the peripheral device can report battery parameters to the central device in at least one response slot of the corresponding subevent.
